(19) United States
(12) Patent Application Publication
(10) Pub. No.: US 2019/0387445 A1
(43) Pub. Date: Dec. 19, 2019

(54) GROUND RADIO STATION

(71) Applicant: Mitsubishi Electric Corporation, Tokyo (JP)

(72) Inventors: Tetsuya AOYAMA, Tokyo (JP); Keijiro TAKE, Tokyo (JP)

(73) Assignee: Mitsubishi Electric Corporation, Tokyo (JP)

(21) Appl. No.: 16/475,762

(22) PCT Filed: Feb. 27, 2017
(86) PCT No.: PCT/JP2017/007333

§ 371 Date: Jul. 3, 2019

(51) Int. Cl. H04W 36/08; H04W 28/26; G06F 16/22

(52) U.S. Cl. CPC H04W 36/08; G06F 16/22; H04W 28/26

(57) ABSTRACT

A ground radio station of a radio communication system which includes a plurality of ground radio stations placed along a movement path of a mobile radio station and in which the mobile radio station switches the ground radio stations to connect to as the mobile radio station moves, the ground radio station including; a radio controller to reserve a radio resource for the mobile radio station in a case where, before the mobile radio station communicates with the ground radio station, the mobile radio station communicates with another ground radio station adjacent to the ground radio station; and a communication-status monitor to monitor a radio signal sent from the mobile radio station to the another ground radio station, wherein, when the communication-status monitor detects that the radio signal is not received for a predetermined time, the communication-status monitor checks communication status between the mobile radio station and the another ground radio station, and wherein, when the communication-status monitor confirms that there is no communication between the mobile radio station and the another ground radio station, the radio controller releases the radio resource.

### TECHNICAL FIELD

The present invention relates to a technology for managing radio resources of ground radio stations placed along a movement path of a mobile radio station.

### BACKGROUND ART

In a radio communication system in which plural ground radio stations (hereinafter, also referred to as ground stations) are placed along a movement path of a mobile radio station (hereinafter, also referred to as mobile station) and in which the mobile station connects to and communicates with a ground station corresponding to a communication area where the mobile station exists so that the mobile station will continue communication while performing handover or namely switching ground stations to be connected according to the mobile station's movement, communication interruptions due to handover are prevented by making a prior reservation for a radio resource of a ground station to which to handover, or by establishing a communication path in an upper layer network in advance.

For example, in a case where a mobile station installed on a train is to communicate with ground stations placed along a railway, reservation is made for the radio resource of a ground station that is located in the train's traveling direction and within the train's braking distance. In order to avoid a phenomenon, which is called here “an unreleased radio resource”, where a radio resource is kept occupied without being used, it is necessary for radio resources to be timely released in a case where they are not used. As a method to release such an unused radio resource, there exists a no-communication monitoring function in which a ground station monitors data received from a mobile station, to detect a radio resource which is not used for receiving for a duration predetermined by a timer, and then determine that the radio resource is not in use. With respect to such a timer value, a method (Patent Document 1) in which a fixed value is used and a method (Patent Document 2) in which the value is varied in accordance with the network load are disclosed.

### PRIOR ART DOCUMENTS

### Patent Documents

Patent Document 1: Unexamined Patent Application Publication JP, 1110-164216, A

Patent Document 2: Unexamined Patent Application Publication JP, 2013-143672, A

### SUMMARY OF THE INVENTION

### Problems to be Solved by the Invention

In a case where ground stations are provided for a radio communication system for trains, the time from reservation of a radio resource to start of communication varies depending on a train's condition such as stopping at or skipping a station, changing or not the traveling direction, and the movement speed varying according to the train operation type. Therefore, when the fixed-timer-value method as shown in Patent Document 1 is used for such a conventional no-communication monitoring function in order to solve “the floating radio-resource” problem, there sometimes arises a problem that in a case where the time to the communication start is longer than the timer value, the radio resource is released before handover, or a problem that in a case where the time to the communication start is shorter than the timer value, the radio resource is occupied more than needed. Even when the timer value is varied according to the network load as shown in Patent Document 2, this does not bring a solution to a problem that the radio resource is released before handover, and to a problem that the radio resource is occupied more than needed when the time to the start of communication is shorter than the timer value.

The present invention is devised to solve such problems and obtain a ground station which can not only reduce occurrences of events in which the radio resource (reserved radio resource) having been reserved in advance for the mobile station handover is released before handover, but also properly release the radio resource when the reserved radio resource becomes unnecessary.

### Solution to Problems

A ground radio station of a radio communication system according to the present invention which includes a plurality of ground radio stations placed along a movement path of a mobile radio station and in which the mobile radio station switches the ground radio stations to connect to as the mobile radio station moves, the ground radio station including: a radio controller to reserve a radio resource for the mobile radio station in a case where, before the mobile radio station communicates with the ground radio station, the mobile radio station communicates with another ground radio station adjacent to the ground radio station; and a communication-status monitor to monitor a radio signal sent from the mobile radio station to the another ground radio station, wherein, when the communication-status monitor detects that the radio signal is not received for a predetermined time, the communication-status monitor checks communication status between the mobile radio station and the another ground radio station, and wherein, when the communication-status monitor confirms that there is no communication between the mobile radio station and the another ground radio station, the radio controller releases the radio resource.

### Advantages of the Invention

In ground radio stations placed along the movement path of a mobile radio station, it becomes possible to reduce the possibilities of events in which a ground radio station's radio resource having been reserved in advance for the mobile radio station is erroneously released before the mobile radio station is get connected to the ground radio station, and also to properly release the reserved radio resource when it becomes unnecessary.

### BRIEF DESCRIPTION OF THE DRAWINGS

FIG. 1 is a schematic view showing a system configuration example of a radio communication system according to Embodiment 1 of the present invention.

FIG. 2 is a block diagram showing a functional configuration example of a ground station according to Embodiment 1.

FIG. 3 is a block diagram showing a hardware configuration example of the ground station according to Embodiment 1.

FIG. 4 is a block diagram showing a functional configuration example of a control station according to Embodiment 1.

FIG. 5 is a block diagram showing a hardware configuration example of the control station according to Embodiment 1.

FIG. 6 is a block diagram showing a functional configuration example of a mobile station according to Embodiment 1.

FIG. 7 is a block diagram showing a hardware configuration example of the mobile station according to Embodiment 1.

FIG. 8 is a sequence diagram showing an operation example of the ground stations according to Embodiment 1.

FIG. 9 is a flow chart showing a snooping operation example of the ground station according to Embodiment 1.

FIG. 10 is a sequence diagram showing an example of communication status confirmation processing of the ground station according to Embodiment 1.

FIG. 11 is a sequence diagram showing an example of resource release processing of the ground station according to Embodiment 1.

FIG. 12 is a schematic view showing a system configuration example of a radio communication system according to Embodiment 2 of the present invention.

FIG. 13 is a block diagram showing a functional configuration example of a ground station according to Embodiment 2.

FIG. 14 is a sequence diagram showing an operation example of the ground stations according to Embodiment 2.

FIG. 15 is a flow chart showing a snooping operation example of the ground station according to Embodiment 2.

FIG. 16 is a sequence diagram showing an example of communication status confirmation processing of the ground station according to Embodiment 2.

FIG. 17 is a sequence diagram showing an example of resource release processing of the ground station according to Embodiment 2.

### DESCRIPTION OF EMBODIMENTS

Hereinafter, embodiments of the present invention will be described in detail with reference to figures. Note that the scope of the present invention is not limited within what is disclosed in the embodiments. In the figures referred to in the following description, the same or equivalent components will be designated by the same symbols.

### Embodiment 1

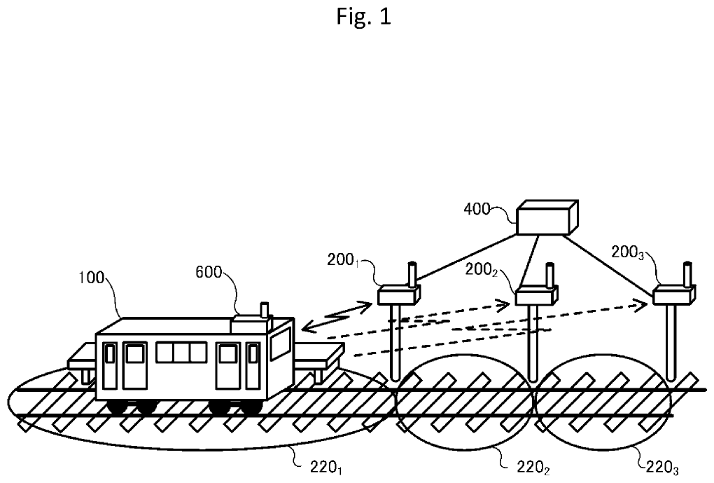

FIG. 1 shows a configuration example of a radio communication system according to Embodiment 1 of the present invention. In FIG. 1, a train 100 is provided with a mobile radio station (mobile station) 600 and the rails on which the train 100 travels are the movement path of the mobile station 600. As shown in FIG. 1, ground radio stations (ground stations) 200 (200₁-200₃) are placed along the railway, and the ground stations 200₁-200₃ have their communication areas 220 (220₁-220₃), respectively. The mobile station 600 connects itself to a ground station 200 whose communication area 220 includes the location thereof, to thereby send and receive control information to and from the connected ground station 200. Here, the control information which the mobile station 600 sends includes information such as the train's location information and the train's traveling direction; and the control information which the mobile station 600 receives includes information such as the speed information, the positional information on where the train is allowed to travel, the speed limit information, and the positional information on where the ground stations are to be switched. The control station 400 connects itself to each of the ground stations 200 to send and receive the control information between the mobile station 600 and the ground station 200, and also mediate radio-resource reservation processing performed between the ground stations 200. Though the connection between the ground station 200 and the control station 400 may be wired or wireless, it is assumed here that the connection is wired. FIG. 1 shows a configuration example of a radio communication system, but the scope of the present invention is not limited to the configuration shown in FIG. 1.

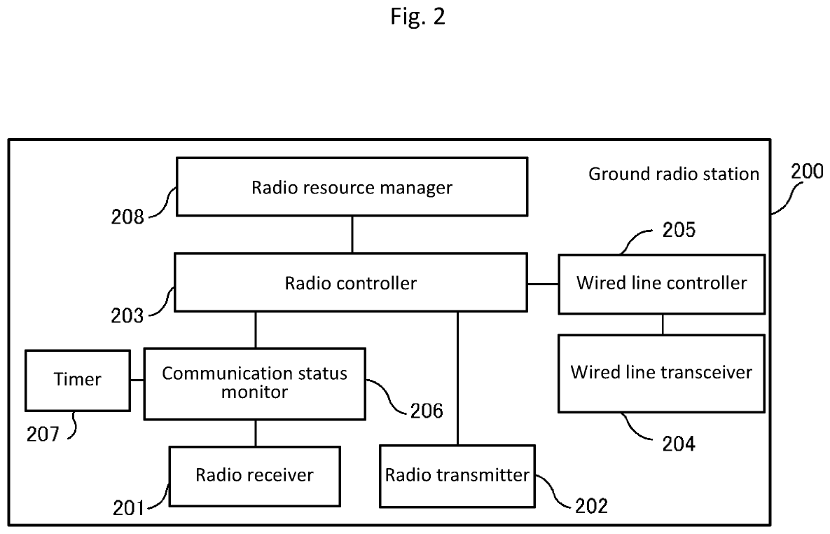

FIG. 2 is a block diagram showing a functional configuration example of each of the ground stations 200 according to the present embodiment. The ground station 200 includes a radio receiver 201, a radio transmitter 202, a radio controller 203, a wired line transceiver 204, a wired line controller 205, a communication-status monitor 206, a timer 207, and a radio resource manager 208.

The radio receiver 201 and the radio transmitter 202 respectively perform a reception operation and a transmission operation of radio signals from and to the mobile station 600. The wired line transceiver 204 uses wires to send and receive signals to and from the control station. The communication-status monitor 206 is connected to the radio receiver 201 and monitors the reception status of radio signals from the mobile station 600. The timer 207 is a timer which the communication-status monitor 206 uses for monitoring the reception status. The wired line controller 205 controls the wired line transceiver 204 so as to process signals received thereby and so as to process signals to be sent thereby. The processing performed by the wired line controller 205 includes protocol processing required for communication via the network.

The radio controller 203 controls radio channels; the radio controller also processes signals received by the radio receiver 201 and processes signals to be sent from the radio transmitter 202. Radio-side information and wired-side information are exchanged between the radio controller 203 and the wired line controller 205. The radio resource manager 208 manages a radio resource required for the ground station 200 to communicate with the mobile station 600. Note here that the radio resource is any one of radio frequency, channel and time which are used for the ground station 200 and the mobile station 600 to perform radio communication, or the radio resource is any combination of two or more thereof.

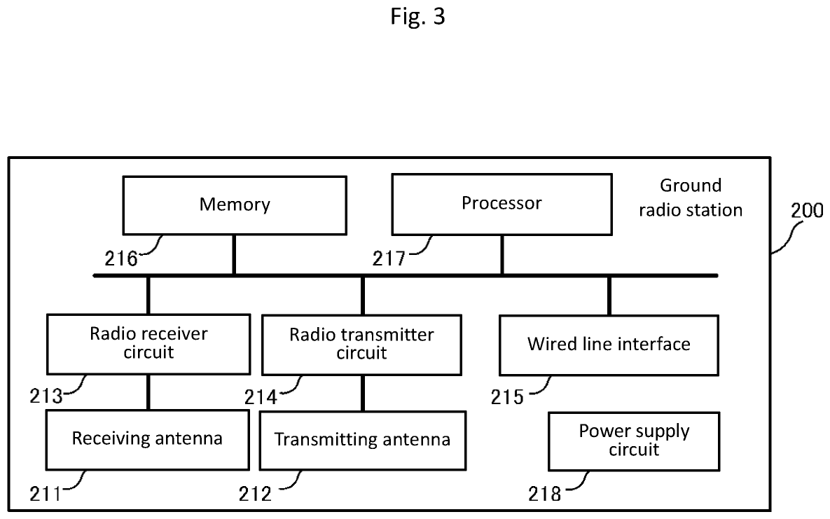

FIG. 3 is a block diagram showing a hardware configuration example of the ground station 200. In FIG. 3, the ground station 200 includes a receiving antenna 211, a transmitting antenna 212, a radio receiver circuit 213, a radio transmitter circuit 214, a wired line interface 215, a memory 216, a processor 217, and a power supply circuit 218.

The receiving antenna 211 and the radio receiver circuit 213 correspond to the radio receiver 201, where the radio receiver circuit 213 performs reception processing with respect to radio signals received by the receiving antenna 211. The reception processing here is usual processing such as frequency conversion, analog-to-digital conversion, demodulation, or decoding which is performed when radio signals are received. The transmitting antenna 212 and the radio transmitter circuit 214 correspond to the radio transmitter 202, where the radio transmitter circuit 214 performs transmission processing with respect to the radio signals to be sent from the transmitting antenna 212. The transmission processing here is usual processing such as encoding, modulation, digital-to-analog conversion, or frequency conversion which is performed when radio signals are sent.

The wired line interface 215 corresponds to the wired line transceiver 204. The wired line interface 215 is, for example, a network interface card (NIC). The processor 217 and the memory 216 correspond to the communication-status monitor 206, the timer 207, the radio controller 203, the radio resource manager 208, and the wired line controller 205, and the functions thereof are realized by a program which is stored in the memory 216 to be executed by the processor 217. Note here that some portions of the functions of the radio receiver 201, the radio transmitter 202, and the wired line transceiver 204 may also be realized by the program. Furthermore, some portions of the functions of the radio controller 203 and the wired line controller 205 may be realized by circuits without using the program.

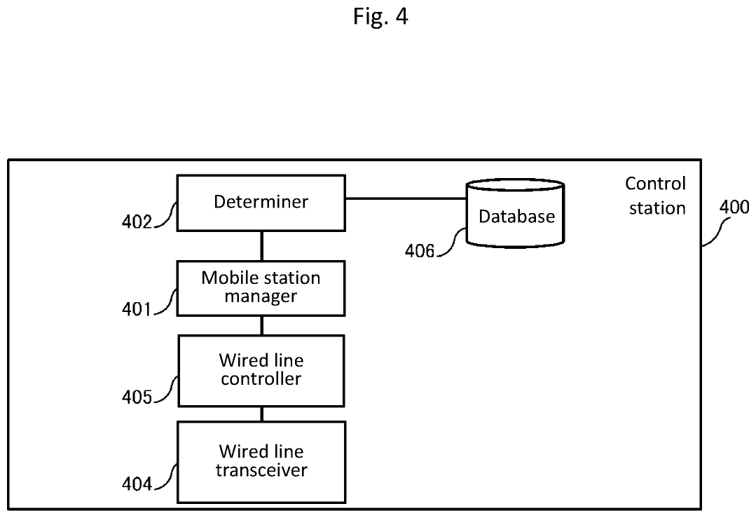

FIG. 4 is a block diagram showing a functional configuration example of the control station 400. The control station 400 includes a wired line transceiver 404, a wired line controller 405, a mobile station manager 401, a determiner 402, and a database 406. The wired line transceiver 404 sends and receives signals to and from the ground stations 200 through wires. The wired line controller 405 controls the wired line transceiver 404 so as to process signals received by the wired line transceiver 404 and so as to process signals to be sent by the wired line transceiver 404. The mobile station manager 401 exchanges information with the ground stations 200 via a wired network and manages the communication status of the mobile station 600. The determiner 402 determines a ground station 200 to which the mobile station 600 is to be connected in accordance with the movement of the mobile station 600. The database 406 records and stores information on the ground stations 200.

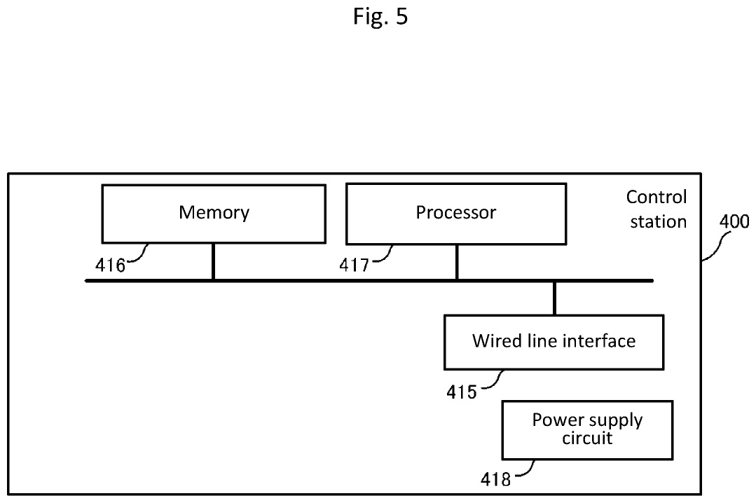

FIG. 5 is a block diagram showing a hardware configuration example of the control station 400. In FIG. 5, the control station 400 includes a wired line interface 415, a memory 416, a processor 417, and a power supply circuit 418. The wired line interface 415 is the same as the wired line interface 215 of the ground station 200. The processor 417 and the memory 416 correspond to the mobile station manager 401 and the determiner 402. The functions thereof are realized by a program which is stored in the memory 416 to be executed by the processor 417. The database 406 is realized by the memory 416.

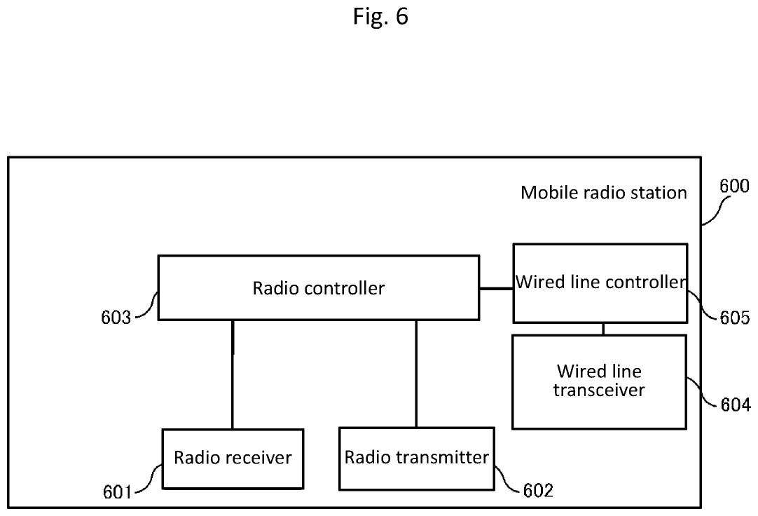

FIG. 6 is a block diagram showing a functional configuration example of the mobile station 600. The mobile station 600 includes a radio receiver 601, a radio transmitter 602, a radio controller 603, a wired line transceiver 604, and a wired line controller 605. The radio receiver 601, the radio transmitter 602, the radio controller 603, the wired line transceiver 604, and the wired line controller 605 are respectively the same as the radio receiver 201, the radio transmitter 202, the radio controller 203, the wired line transceiver 204, and the wired line controller 205 of the ground station 200. In addition, the wired line transceiver 604 of the mobile station 600 is connected to other devices on the train.

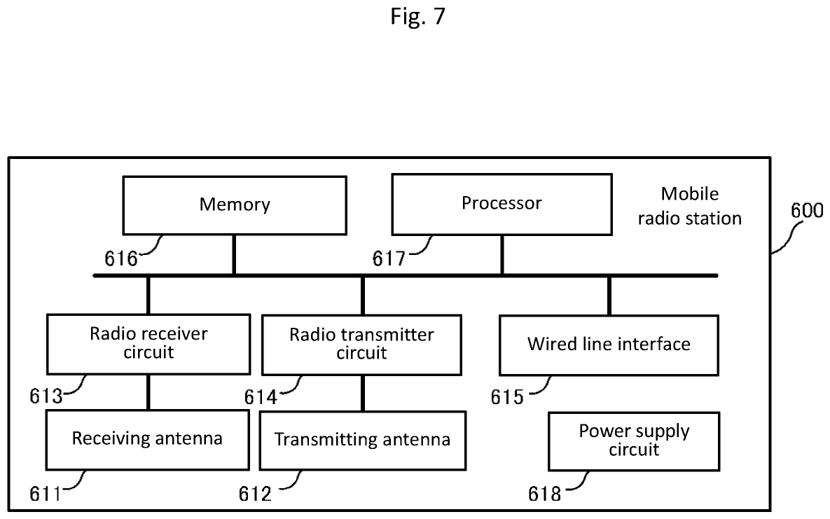

FIG. 7 is a block diagram showing a hardware configuration example of the mobile station 600. The mobile station 600 includes a receiving antenna 611, a transmitting antenna 612, a radio receiver circuit 613, a radio transmitter circuit 614, a wired line interface 615, a memory 616, a processor 617, and a power supply circuit 618. Similarly to the ground station 200, the receiving antenna 611 and the radio receiver circuit 613 correspond to the radio receiver 601. Also, the transmitting antenna 612 and the radio transmitter circuit 614 correspond to the radio transmitter 602. The wired line interface 615 corresponds to the wired line transceiver 604. The processor 617 and the memory 616 correspond to the radio controller 603. The functions thereof are realized by a program which is stored in the memory 616 to be executed by the processor 617.

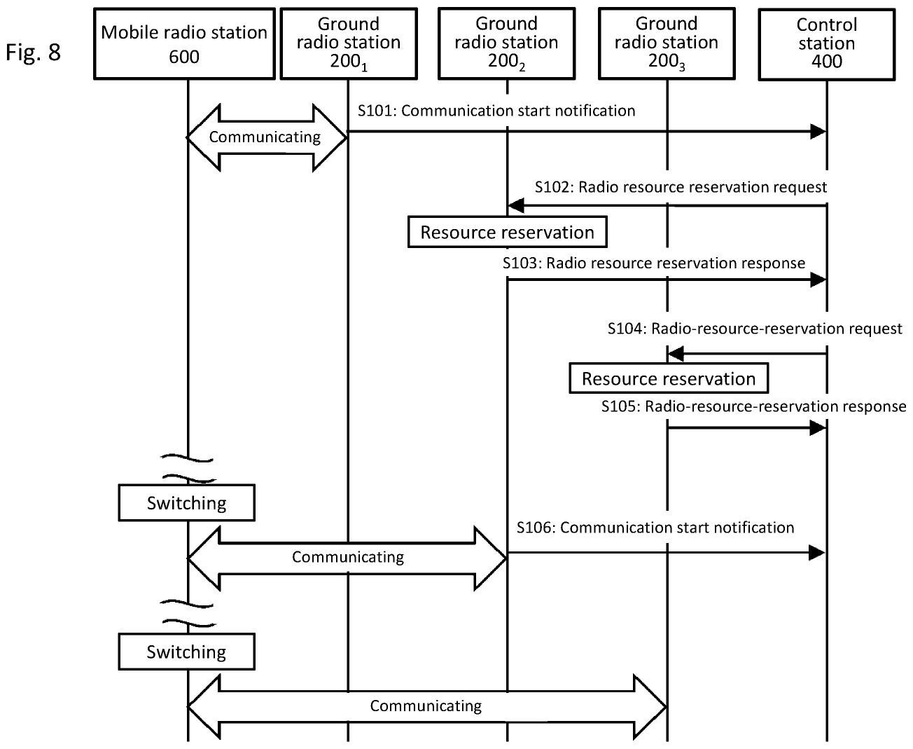

Next, the operation will be described. For easily understanding the description, a sequence diagram will be used which shows the processing procedures performed by the ground stations 200, the control station 400 and the mobile station 600. First, a sequence diagram shown in FIG. 8 is used for describing an operation example in which the ground stations 200 reserve radio resources for the mobile station 600. FIG. 8 shows an example of a radio-resource reservation sequence based on the configuration example shown in FIG. 1, and shows that the mobile station 600 being connected to the ground station 200₁ moves toward the ground station 200₂ and then reserves a radio resource of the adjacent ground station 200₂.

The mobile station 600 is being connected to the ground station 200₁, and the mobile station 600 and the ground station 200₁ are communicating the above-described control information with each other. When communicating with the mobile station 600, the radio controller 203 (hereinafter, it is referred to as a radio controller 203₁ and other components will be denoted in the same way) sends a communication-start notification message to the control station 400 via the wired line controller 2051 and the wired line transceiver 2041 in order to reserve a radio resource of a ground station 200 to which the mobile station 600 is to be next connected (S101). The communication-start notification message includes information such as an identifier for the mobile station 600, an identifier for the ground station 200₁ to which the mobile station 600 is being connected, and radio resource information which the ground station 200₁ has assigned to the mobile station 600.

In the control station 400, the mobile manager 401 is notified of the communication-start notification message, via the wired line transceiver 404 and the wired line controller 405. On the basis of the received communication-start notification message, the mobile station manager 401 performs processing for registering the identifier of the ground station 200₁ to be connected with the mobile station 600 and radio resource information assigned to the mobile station 600 by the ground station 200₁, to manage the communication status of the mobile station 600. Then, on the basis of the processing result of the mobile station manager 401, the determiner 402 determines, referring to the database 406, a ground station to which the mobile station 600 is to be next connected. The database 406 stores, with respect to each of the traveling directions of the mobile station 600, data of identifiers for identifying a ground station 200 with which the mobile station 600 is currently communicating and identifiers for identifying a ground station 200 to be next connected. By referring to the database 406 on the basis of the traveling direction of the mobile station 600 and the identifier which is the processing result of the mobile manager 401 and which identifies the currently-communicating ground station 200, the determiner 402 can determine a ground station 200 to which the mobile station 600 is to be next connected. In this example, the ground station 200₂ is determined as a ground station 200 to be next connected. Then the determiner 402 sends a radio-resource-reservation request message to the ground station 200₂ via the mobile station manager 401, the wired line controller 405, and the wired line transceiver 404 (S102). The radio-resource-reservation request message includes the identifier of the mobile station 600 and the radio resource information on the radio resource currently used between the mobile station 600 and the ground station 200₁.

In the ground station 200₂, the radio-resource-reservation request message is received and processed by the wired line transceiver 204₂ and the wired line controller 205₂, to be notified to the radio controller 203₂. In response to the radio-resource-reservation request message received, the radio controller 203₂ reserves, out of radio resources managed by its radio resource manager 208, a radio resource required for communication with the mobile station 600. As previously mentioned, the radio resource is any one of radio frequency, channel and time, or the radio resource is any combination of two or more thereof.

Then, the communication-status monitor 206₂ of the ground station 200₂ sets a predetermined timer value to the timer 207₂ and starts monitoring (snooping) the communication status between the mobile station 600 and the ground station 200₁. The snooping operation will be described later in detail. The ground station 200₂ can monitor the radio signals sent from the mobile station 600 to the ground station 200₁ by receiving radio signals that are currently being sent and received therebetween at the frequency channel which is written in the information of the radio resources that are being used for the communication between the mobile station 600 and the ground station 200₁ Then, the radio controller 203₂ of the ground station 200₂ sends a radio-resource-reservation response message to the control station 400 via the wired line controller 205₂ and the wired line transceiver 204₂ (S103). The radio-resource-reservation response message is a message which includes information on an identifier to identify the mobile station 600.

In the control station 400, the radio-resource-reservation response message is received and processed by the wired line transceiver 404 and the wired line controller 405, to be notified to the determiner 402 via the mobile station manager 401. Being notified of the radio-resource-reservation response message, the determiner 402 refers to the database 406 to determine the ground station 200₃ to which the mobile station 600 is to be connected after the ground station 200₂, and then sends a radio-resource-reservation request message to the determined ground station 200₃ (S104). The ground station 200₃ reserves a radio resource for the mobile station 600 in the same way as in the ground station 200₂ described above, to monitor the communication status between the mobile station 600 and the ground station 200₂. Then, the ground station 200₃ sends a radio-resource-reservation response message to the control station 400 (S105).

When the mobile station 600 detects that the mobile station has moved from the communication area 220₁ of the ground station 200₁ into the communication area 220₂ of the ground station 200₂, the mobile station 600 switches its connection from the ground station 200₁ to the ground station 200₂. The mobile station 600 switches its connecting ground stations when, for example, the mobile station 600 detects, using the information of its current position obtained from the train, that the mobile station 600 has passed a switching position included in the control information obtained from the ground station 200. In this, the mobile station 600 switches radio resources used for communicating with the ground station 200 from the radio resources of the ground station 200₁ to the radio resources of the ground station 200₂. To be more specific, the frequency channel and the transmission time are switched from those of the ground station 200₁, to those of the ground station 200₂. When the mobile station 600 switches its connection to the ground station 200₂, the mobile station 600 and the ground station 200₂ start communication with each other to send and receive their control information. When the mobile station 600 and the ground station 200₂ start communicating with each other, the radio controller 203₂ of the ground station 200₂ sends, in the same way as the ground station 200₁ operates, a communication start notification to the control station 400 (S106).

When the mobile station 600 moves from the communication area 220₂ of the ground station 200₂ into the communication area 220₃ of the ground station 200₃, the mobile station 600 switches, in the same way, its connection from the ground station 200₂ to the ground station 200₃.

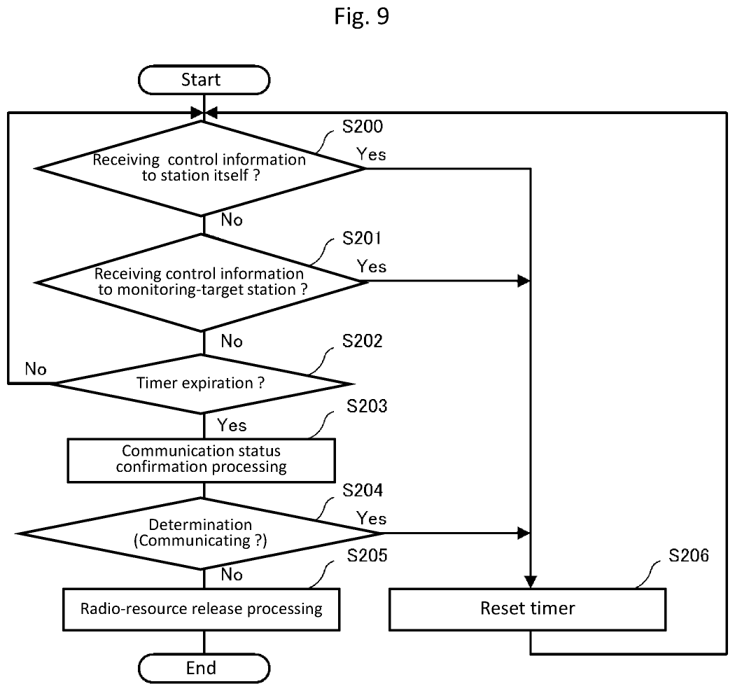

Next, the snooping operation performed by the ground station 200 will be described. FIG. 9 is a flow chart showing the snooping operation performed by the ground station 200. As previously described, in response to receiving a radio-resource-reservation request message from the control station 400, the ground station 200 starts the snooping operation. The communication-status monitor 206 of the ground station 200 performs the snooping operation, using information of the identifier of the mobile station 600 and the radio resource therefor included in the radio-resource-reservation request message. At the start of the snooping operation, the communication-status monitor 206 checks whether or not the ground station has received control information addressed to itself from the mobile station 600 (S200). In a case where the ground station has received control information addressed to itself, the communication-status monitor 206 resets the timer 207 (S206). After the processing step of S206, the communication-status monitor 206 repeats the processing step of S200.

In a case where, in the processing step of S200, the ground station has not received control information addressed to itself, the communication-status monitor 206 checks whether or not the ground station has received a radio signal addressed to a monitoring-target station (S201). In a case where the ground station has received the signal, the communication-status monitor 206 performs the processing step of S206. In a case where the ground station has not received it, the communication-status monitor 206 checks whether or not the timer 207 has expired (S202). In a case where the timer 207 has not expired in the processing step of S202, the communication-status monitor 206 performs the processing step of S200 again.

Next, the processing to be performed after the expiration of the timer 207 will be described. One of the cases where the timer 207 expires is a case where a predetermined certain period has passed without using the radio resources, which were reserved in response to the reception of a radio-resource-reservation request message, for the communication with the mobile station 600. Another case is a case where a predetermined certain period has passed without catching the communication between the mobile station 600 and another ground station using the radio resources indicated by the radio-resource-reservation request message. When the timer 207 has expired, the communication-status monitor 206 of the ground station 200 performs a process for checking the communication status of the mobile station 600 (S203).

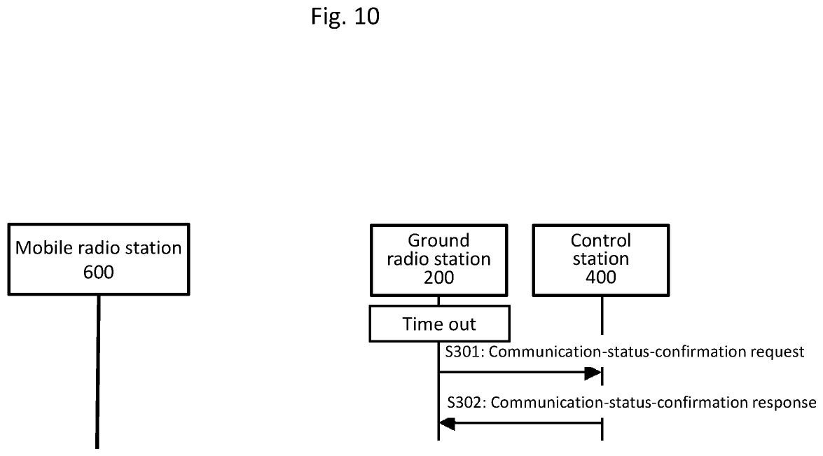

Because the communication status confirmation processing of S203 is performed together with the control station 600, the processing will be described with reference to the sequence diagram shown in FIG. 10. In the communication status confirmation processing, the communication-status monitor 206 of the ground station 200 sends a communication-status-confirmation request message to the control station 400 via the radio controller 203, the wired line controller 205, and the wired line transceiver 204 (S301). In addition, the communication-status-confirmation request message includes an identifier to identify the mobile station 600. In the control station 400, the communication-status-confirmation request message is received and processed by the wired line transceiver 404 and the wired line controller 405, to be notified to the mobile station manager 401. The mobile station manager 401 checks the communication status of the mobile station 600 and sends, to the ground station 200 via the wired line controller 405 and the wired line transceiver 404, a communication-status-confirmation response message which includes information on whether or not the mobile station is communicating (S302). Note here that the control station 400 has obtained the communication status of the mobile station 400 through the communication-start notification message. The communication-status monitor 206 of the ground station 200 obtains the communication-status-confirmation response message sent from the control station 400.

After the processing of S203, the communication-status monitor 206 determines, on the basis of the communication-status-confirmation response message, whether or not the mobile station 600 is communicating (S204). In a case where determining that the mobile station 600 is communicating, the communication-status monitor 206 performs processing of S206. Also, when determining that the mobile station is not communicating, the communication-status monitor determines that the radio resources being reserved for the mobile station 600 have become unnecessary to be kept reserved, and then performs radio-resource release processing (S205).

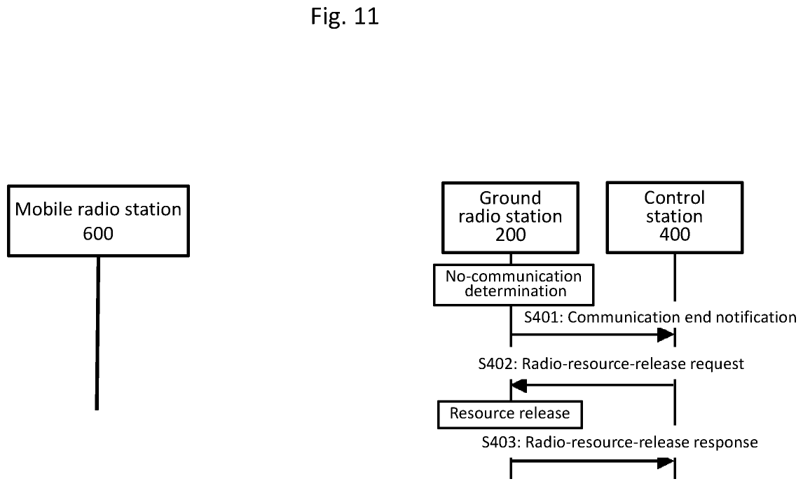

Because the radio-resource release processing of S205 cooperates with the control station 400, the radio-resource release processing will be described with reference to a sequence diagram shown in FIG. 11. The communication-status monitor 206 of the ground station 200 sends a communication-end notification message to notify the control station 400 that the mobile station 600 ended its communication (S401). The mobile station manager 401 of the control station 400 processes the communication-end notification message, and then the mobile station manager 401 sends a radio-resource-release request message to a ground station 200 keeping its radio resource reserved for the mobile station 600, to request to release its radio resources reserved for the mobile station 600 (S402). Radio-resource-release request messages are sent to ground stations 200 that are keeping their radio resources reserved for the mobile station 600.

In the ground station 200, the radio controller 203 is notified of the radio-resource-release request message via the wired line transceiver 204 and the wired line controller 205. Then, the radio controller 203 issues an instruction to the radio resource manager 208, and then the radio resource manager 208 releases the radio resource secured for the mobile station 600. The radio resource controller 203 releases the radio resource, and then sends a radio-resource-release response message to the control station 400 via the wired line controller 205 and the wired line transceiver 204 (S403).

In the above example, the radio-resource release processing has been described in a case where the timer 207 expires in the processing step of S202; however, also in a case where the connection between the terminal 600 and the ground station 200 is explicitly terminated, the radio resource may be released in response to the disconnection with the terminal 600.

The advantages obtained by the present embodiment described so far are as follows. Even when, in a radio communication system in which a ground radio station connected to a mobile radio station is switched to another ground radio station according to the movement of the mobile radio station, a radio resource reserved in the another ground radio station to be connected to the mobile radio station is not used for a predetermined duration, a control station which manages the communication status of the mobile radio stations performs processing to confirm the communication status of the mobile radio station, and then the radio resource is released if confirming that the mobile radio station does not communicate. This prevents the reserved radio resource from being erroneously released. Also, in a case where a reserved resource has not been used for a predetermined duration and then the control station has confirmed that the mobile station does not communicate, the reserved resource is to be released. This can reduce possibilities to unnecessarily keep reserving radio resources.

### Embodiment 2

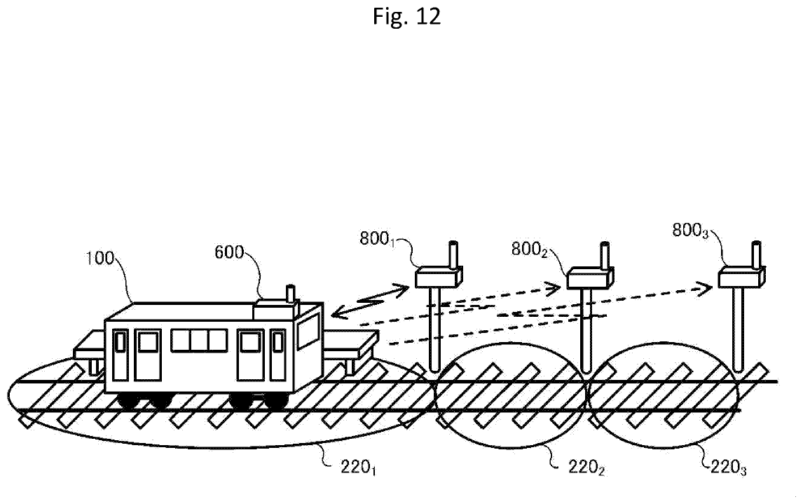

In Embodiment 2, an embodiment will be described in which the control station and the ground radio station are integrated into an apparatus and then placed. FIG. 12 shows a configuration example of a radio communication system according to the present embodiment. FIG. 12 has a difference from FIG. 1 as follows. No control station is provided in the system shown in FIG. 12, in which, instead of the ground radio stations 200 in FIG. 1, there placed are ground radio stations 800 (800₁ to 800₃) each provided with the function of the control station.

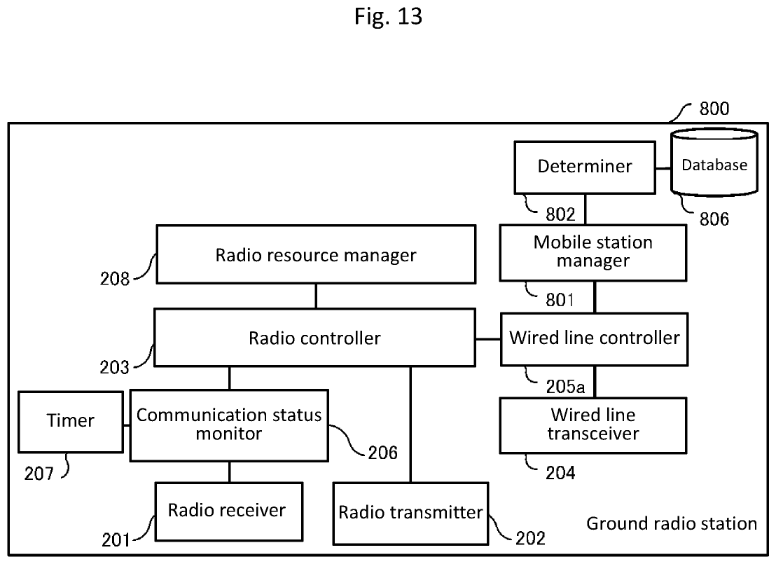

FIG. 13 is a block diagram showing a functional configuration example of each of the ground radio stations 800 according to the present embodiment. The ground radio station 800 according to the present embodiment is different from the ground radio station 200 according to Embodiment 1 shown in FIG. 2 in that the ground radio station 800 further includes a mobile station manager 801 connected to a wired line controller 205a, a determiner 802 connected to the mobile station manager 801, and a database 806 connected to the determiner 802. The mobile station manager 801, the determiner 802, and the database 806 respectively correspond to the mobile station manager 401, the determiner 402, and the database 406 of the control station 400 shown in FIG. 4. The ground radio station 800 according to the present embodiment can be configured with the same hardware as the hardware of the ground radio station 200 shown in Embodiment 1.

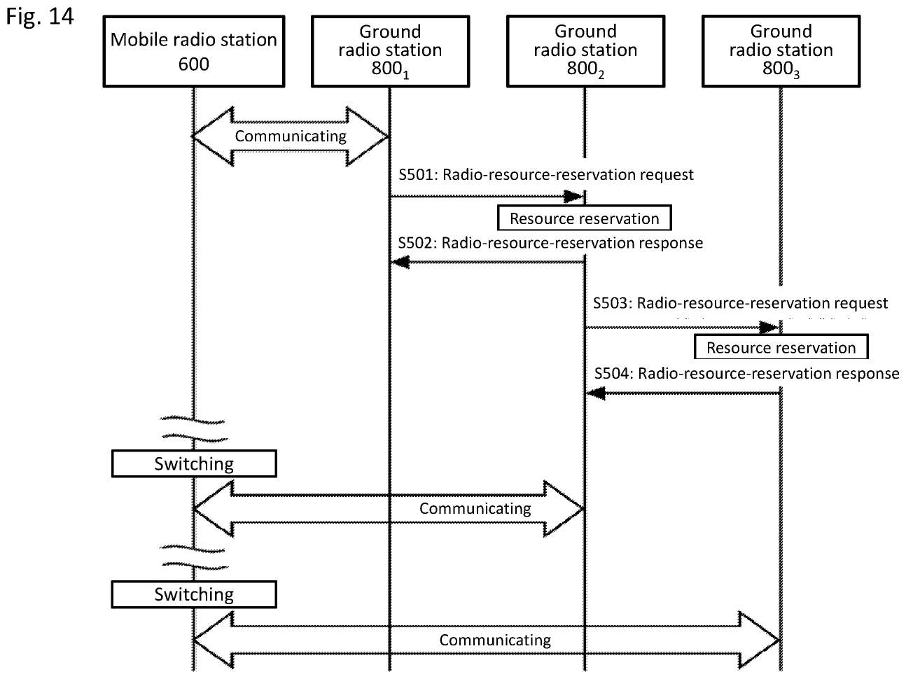

Next, the operation of the ground station 800 according to the present embodiment will be described focusing on points different from the operation of the ground station 200 according to Embodiment 1. FIG. 14 is a sequence diagram, by which the ground stations 800 based on the configuration example shown in FIG. 13 reserve radio resources. FIG. 14 shows a sequence, by which a radio resource of the ground station 800₂ is reserved when the mobile station 600 connected to the ground station 800₁ moves toward the ground station 800₂.

When starting communication with the mobile station 600, the ground station 800₁ starts radio resource reservation processing for the ground station 800₂ to which the mobile station 600 is to be connected next. To be more specific, a radio controller 203₁ of the ground station 800₁ notifies a wired line controller 205a₁ of an in-station message which includes the same content as the communication-start notification message in Embodiment 1. 205a₁ notifies a station manager 801₁ of the message received from the radio controller 203₁. The mobile station manager 801₁ performs the same process as that performed by the mobile station manager 401 in the control station 400 of Embodiment 1. Then, with reference to a database 806₁, a determiner 802₁ performs the same process as that performed by the determiner 402 of the control station 400 of Embodiment 1 and selects the ground station 800₂ to which the mobile station 600 is to be connected next. Then, a radio-resource-reservation request message is sent to the ground station 800₂ via the mobile station manager 801₁, the wired line controller 205a₁, and the wired line transceiver 2041 (S501).

The ground station 800₂ performs the same process as in Embodiment 1, to send a radio-resource-reservation response message (S502). Here, the radio-resource-reservation response message is sent to the ground station 800₁. Also, a radio controller 203₂ of the ground station 800₂ notifies, via a wired line controller 205a₂, a mobile station manager 8012 of an in-station message which is the same as the communication-start notification message. After that, the same processes as performed in the ground station 800₁ are performed, and then a radio-resource reservation request is sent to the ground station 800₃ (S503). By this transmission, a radio resource is reserved in the ground station 800₃, and a radio-resource-reservation response message is sent from the ground station 800₃ to the ground station 800₂ (S504).

When the mobile station 600 moves from a communication area 220₁ of the ground station 800₁ into a communication area 220₂ of the ground station 800₂, the mobile station 600 switches its connection to the ground station 800₂ in the same manner as described in Embodiment 1. When the mobile station 600 further moves from the communication area 220₂ of the ground station 800₂ into a communication area 220₃ of the ground station 800₃, the mobile station 600 switches its connection to the ground station 800₃.

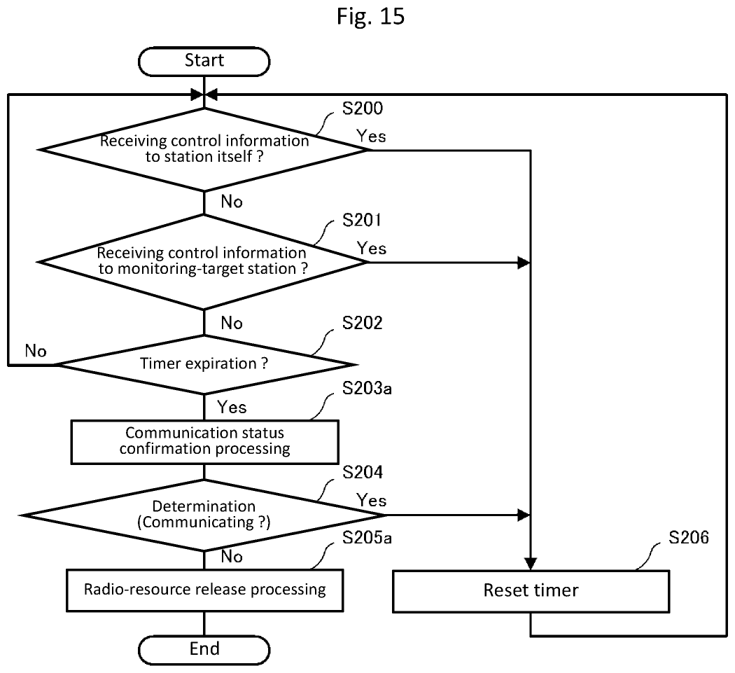

FIG. 15 is a flow chart showing an example of the processing flow according to which the ground station 800 monitors (snooping) the communication status of the mobile station 600. When compared with the snooping operation performed by the ground station 200 of Embodiment 1, the processing content differs in communication status confirmation processing (S203a) and radio-resource release processing (S205a).

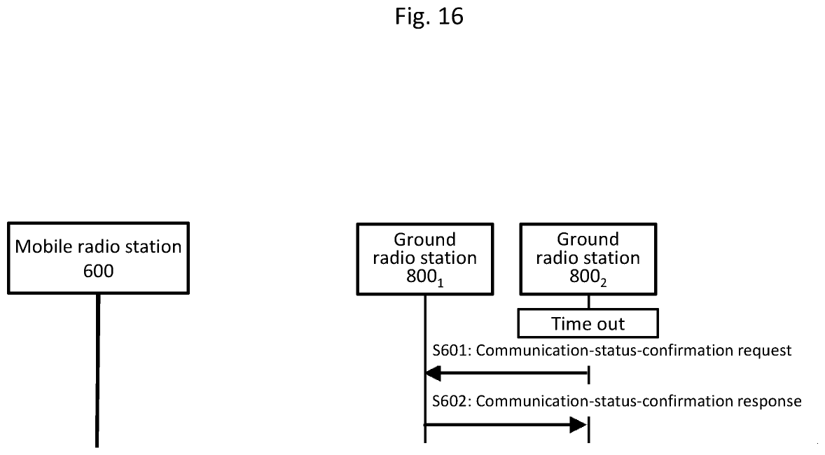

The communication status confirmation processing of S203a will be described with reference to a sequence diagram shown in FIG. 16 because this processing cooperates with another ground station 800. Here, an operation example will be described in which the ground station 800₂ receives a radio-resource-reservation request message from the ground station 800₁, to reserve a radio resource. In the communication status confirmation processing of the present embodiment, a communication-status monitor 206₂ of the ground station 800₂ notifies, via the radio controller 203, the wired line controller 205a₂ of an in-station message which includes the same content as the communication-status-confirmation request message of Embodiment 1. The wired line controller 205a₂ notifies the mobile station manager 8012 of the received in-station message. The mobile station manager 8012 determines whether the ground station 800₂ has already connected to the mobile station 600 or not; if it has not connected yet, the mobile station manager 8012 sends, via the wired line controller 205a₂ and the wired line transceiver 204₂, a communication-status-confirmation request message to a radio station 800 that, previously to the ground station 800₂, has been communicating with the mobile station 600, i.e. the ground station 800₁ that had sent the radio-resource-reservation request message to the ground station 800₂ (S601). Here, the content of the communication-status-confirmation request message is the same as in Embodiment 1. In addition, the mobile station manager 8012 refers to the communication status updated by the communication-start notification message or the communication-end notification message, whereby the mobile station manager 8012 can determine whether or not the mobile station 600 is connected to the ground station 800₂.

In the ground station 800₁ which has received the communication-status-confirmation request message, the mobile station manager 801₁ is notified of the communication-status-confirmation request message. The mobile station manager 801₁ checks the communication status of the mobile station 600 and then sends, via the wired line controller 205a₁ and the wired line transceiver 2041 to the ground station 800₂, a communication-status-confirmation response message including information on whether or not the mobile station 600 is communicating (S602). In addition, the way for the mobile station manager 801₁ to check the communication status of the mobile station 600 is the same as that performed by the mobile station manager 401 of the control station 400 of Embodiment 1. The communication-status monitor 206₂ of the ground station 800₂ obtains the communication-status-confirmation response message.

The communication status confirmation processing with respect to the mobile station 600 which is already connected to the ground station 800₂ is performed on the basis of the determination made by the mobile station manager 801 of the ground station 800₂. The processing contents of the mobile station manager 801 are the same as described above.

The radio-resource release processing of S205a is performed inside the ground station 800, and is substantially the same as the processing performed by the ground station 200 and the control station 400 shown in FIG. 11. To be more specific, the communication-status monitor 206 of the ground station 800 notifies the mobile station manager 801 in the same ground station of a message whose content is the same as the communication-end notification message, to notify the manager of the end of communication. The mobile station manager 801 instructs the radio controller 203 to release the radio resource secured for the mobile station 600, and then the radio controller 203 instructs the radio resource manager 208 to release the radio resource. After the radio resource is released, the radio controller 203 notifies the mobile station manager 801 of completing releasing the radio resource.

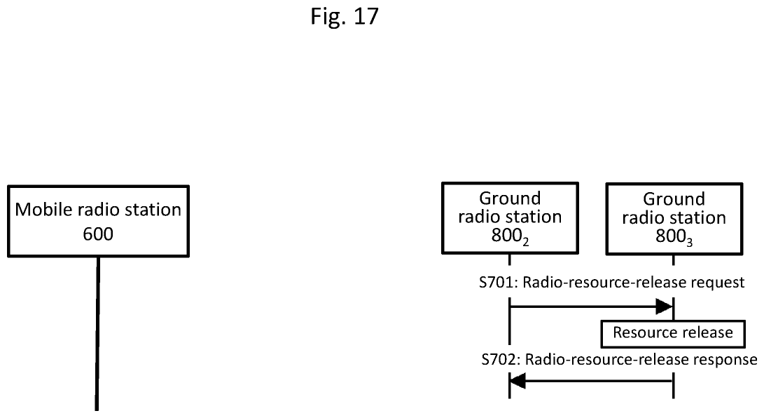

As shown in the sequence in FIG. 17, the mobile station manager 801 may instruct another ground station 800 to release a radio resource. FIG. 17 shows an example in which the ground station 800₂ sends a radio-resource reservation request to the ground station 800₃ and then the ground station 800₃ reserves the radio resource. The mobile station manager 8012 of the ground station 800₂ sends a radio-resource-release request message to the ground station 800₃ (S701). Upon receiving the radio-resource-release request message, the ground station 800₃ performs the same processing as described in Embodiment 1 and sends a radio-resource-release response message to the ground station 800₂ (S702). The radio-resource-release response message is received by the ground station 800₂, within which the mobile station manager 8012 is notified of the message. Further, if there is a ground station 800 that has reserved a radio resource in response to a radio-resource-reservation request message from the ground station 800₃, the mobile station manager 801₃ of the ground station 800₃ sends a radio-resource-release request to the ground station 800 after releasing the radio resources of the ground station 800₃ itself.

The advantages obtained by the present embodiment are as follows: in a case when a radio resource is reserved in a ground radio station to which the mobile radio station is to be connected next, the reserved radio resource is prevented from being erroneously released, without providing the control station; and in a case when the reserved resource is not used for a predetermined duration and the mobile radio station is not communicating, the reserved resource is released, thereby reducing possibilities to unnecessarily keep reserving radio resources.

Description of Symbols

100: train,
200(200₁-200₃): ground radio station (ground station),
201: radio receiver,
202: radio transmitter,
203: radio controller,
204: wired line transceiver,
205: wired line controller,
206: communication-status monitor,
207: timer,
208: radio resource manager,
211: receiving antenna,
212: transmitting antenna,
213: radio receiver circuit,
214: radio transmitter circuit,
215: wired line interface,
216: memory,
217: processor,
218: power supply circuit
220 (220₁-220₃): communication area,
400: control station,
401: mobile station manager,
402: determiner,
404: wired line transceiver,
405: wired line controller,
406: database,
415: wired line interface,
416: memory,
417: processor,
418: power supply circuit,
600: mobile radio station (mobile station),
601: radio receiver,
602: radio transmitter,
603: radio controller,
604: wired line transceiver,
605: wired line controller,
611: receiving antenna,
612: transmitting antenna
613: radio receiver circuit,
614: radio transmitter circuit,
615: wired line interface,
616: memory,
617: processor,
618: power supply circuit,
800 (8001-8003): ground radio station (ground station),
205a: wired line controller,
801: mobile station manager,
802: determiner,
806: database

1-3. (canceled)

4. A ground radio station of a radio communication system which includes a plurality of ground radio stations placed along a movement path of a mobile radio station and in which the mobile radio station switches the ground radio stations to connect to as the mobile radio station moves, the ground radio station comprising:
a processor to execute a program; and
a memory to store the program which, when executed by the processor, performs processes of,
reserving a radio resource for the mobile radio station in a case where, before the mobile radio station communicates with the ground radio station, the mobile radio station communicates with another ground radio station adjacent to the ground radio station; and
monitoring a radio signal sent from the mobile radio station to the another ground radio station,
wherein, when in the monitoring process it is detected that the radio signal is not received for a predetermined time, the program further performs a process of checking communication status between the mobile radio station and the another ground radio station,
and wherein, when in the communication status checking process it is confirmed that there is no communication between the mobile radio station and the another ground radio station, the program further performs a process of releasing the radio resource.

5. The ground radio station according to claim 4, wherein the program further performs a process of
managing a communication status between the mobile radio station and the ground radio station,
wherein the communication-status checking is performed with respect to the another ground radio station which, prior to the ground radio station, communicates with the mobile radio station,
and wherein in a case where the ground radio station is requested to report its communication status from the another ground radio station, whether or not the ground radio station is in communication with the mobile radio station is replied in the communication-status managing.

6. The ground radio station according to claim 4, further comprising
a database to store information on the plurality of ground radio stations in the memory,
wherein the program further performs a process of referring to the database and then determining a next ground radio station to which the mobile radio station is to connect after the ground radio station,
and wherein, in a case where the mobile radio station starts communication with the ground radio station, the program further performs, in the radio-resource reserving, a process of requesting the next ground radio station being judged to be a ground radio station for the mobile radio station to connect after the ground radio station, to reserve its radio resource.

7. The ground radio station according to claim 5, further comprising
a database to store information on the plurality of ground radio stations in the memory,
wherein the program further performs a process of referring to the database and then determining a next ground radio station to which the mobile radio station is to connect after the ground radio station,
and wherein, in a case where the mobile radio station starts communication with the ground radio station, the program further performs, in the radio-resource reserving, a process of requesting the next ground radio station being judged to be a ground radio station for the mobile radio station to connect after the ground radio station, to reserve its radio resource.
